(19) United States
(12) Patent Application Publication
(10) Pub. No.: US 2021/0251150 A1
(43) Pub. Date: Aug. 19, 2021

(54) ORIGINAL SINGLE BLADE PLANT PRUNER

(71) Applicant: Chad Eric DORTON, Acton, CA (US)

(72) Inventor: Chad Eric DORTON, Acton, CA (US)

(21) Appl. No.: 17/227,716

(22) Filed: Apr. 12, 2021

Related U.S. Application Data
(63) Continuation-in-part of application No. 16/131,496, filed on Sep. 14, 2018.
(60) Provisional application No. 62/606,249, filed on Sep. 15, 2017.

(51) Int. Cl. A01G 3/02

(52) U.S. Cl. CPC A01G 3/02

(57) ABSTRACT

The present invention is a plant pruner. The plant pruner comprises a u-shaped housing with a single removable blade. The blade is locked into the u-shaped housing to secure the blade from moving during the process of cutting. It is important to have a single blade that cuts onto a flat surface so there is no damage being done to the fibers at the end of a cutting.

### CROSS-REFERENCE TO RELATED APPLICATIONS

This application is a continuation in part application of U.S. patent application Ser. No. 16/131,496 filed Sep. 14, 2018, which claims benefit of U.S. Provisional Patent Application No. 62/606,249, filed Sep. 15, 2017. The entire contents of which are hereby incorporated by reference.

### BACKGROUND

Plants are pruned today by using scissor type cutters. Today's plant pruners function with a scissor type, double blade cutting mechanism.

When pruning with scissor type cutters, the double blade cutting mechanism smashes the stem/cellular wall of the plant. When the cellular wall of a plant is damaged it takes longer for the new shoot or new node to grow.

Another problem with pruning a plant with double blade cutting mechanism is you have to sharpen the cutter. Even having the sharpest scissor type cutter, you will still have damage to the cellular wall of the plant.

When using scissor type cutters, you must clean multiple blades to minimize the number of bacteria that is being transferred on to the plant limb.

Plant pruning is a very time consuming and tedious process which needs to remain sanitary, precise and safe throughout the process. The way plant pruning is done today is not the most effective or efficient process.

U.S. Pat. No. 5,438,759 to Dieringer, is a Button Removal Device. Although the device has the u-shaped housing, it is used to remove buttons from card stock.

U.S. Pat. No. D485,014 S to LaMagna and Giampaoli, is a Cuticle Nipper Tweezer. The Tweezer has the u-shaped housing; however, it is designed to nip cuticles.

U.S. Pat. No. 8,984,754 B1 to Kaidi and Shamsapour, is a Nail Clipper with Blade Insert. The Nail Clipper has the u-shaped housing and removal blade, it is designed to cut finger or toenails.

U.S. Pat. No. 8,429,825 B2 to Johanson, is a Cutting Apparatus. The Cutting Apparatus has the u-shaped housing with a slot for the blade to push through to an activated position, with the cutting edge extending outwardly of the slot and guide. The Apparatus is used to cut various materials such as paperboard or corrugated paper.

U.S. Pat. No. 5,353,505 to Okada, is Grip Scissors. The Scissors have the u-shaped housing with two blades that slide past each other. The Grip Scissors are used for thread-cutting.

U.S. Pat. No. 4,092,776 to Ferguson, is a Cutting Tool. The Cutting Tool has the u-shaped housing with two blades which are able to crossover and clear said cutting surface.

Pat. No. Des. 273,172 to Yamagishi, is a Thread Nipper or The Like. The Thread Nipper has the u-shaped housing with two blades that crossover. The purpose of the Thread Nipper is thread-cutting.

U.S. Pat. No. D613,571 S to Quante, is a Cutting Implement. The Cutting Implement has the u-shaped housing with two crossover blades.

U.S. Pat. No. 5,016,353 to Iten, is a Suture Cutter. The Suture Cutter has the u-shaped housing with a blade that functions as a probe. It provides a suture cutter for cutting sutures in a skin surface.

U.S. Pat. No. 4,053,979 to Tuthill and Freeborn, is a Suture Cutter. The Suture Cutter has the u-shaped housing and removes surgical sutures with a slicing action.

U.S. Pat. No. 5,711,075 to Wolf, is a Unitarily Formed Plastic Soft Tissue Nipper. The Soft Tissue Nipper has the u-shaped housing with two blades at the end of each arm. The blades are required to be urged into abutting edge-to-edge contact. The purpose of the Soft Tissue Nipper is to be a hand-held tool for removing soft tissue, such as cuticles at base of fingernails.

U.S. Pat. No. 7,730,620 B1 to Anastasi, is a Plastic Package Opener. The Package Opener has the u-shaped housing with a blade member is mounted within the interior surface of an angled leg in order for the blade member to be directed across the surface of a plastic package.

The description of prior art all have the u-shaped housing, however serve the purpose of something other than Plant Pruning.

### SUMMARY

The present invention, The Original Single Blade Plant Pruner, does not require using a scissor type cutter with two blades to prune plants. The embodiment of the invention is a single blade mounted into the u-shaped housing that presses firmly against a flat surface. Only one blade is used, in order to remove the limb of a plant without damage. Plant pruning with the present invention is not hard on the plant and allows new nodes to reproduce immediately. The present invention prunes without the crushing of the plant limbs. The present invention allows the blade to remain sanitized which allows for a clean, precise cut. The present invention allows for you to make multiple cuts with the same precision as the first in the circumstance you made your first cut incorrectly. The present invention has an easy squeeze function which allows for easy, safe use in either hand. It allows even the novice pruner ease of use.

Plant pruning is important in everyone's everyday life. Plant pruning is a huge industry. Having plants remain undamaged during the pruning phase is a huge breakthrough that will benefit the entire world. Plant pruning is important to the world because: almost all fruits and vegetables that are consumed around the world comes from a plant that has been pruned. Almost all plants, flowers and trees must be pruned to achieve high levels of produce. Being able to prune a plant without damaging the plant limb allows the plant to reproduce quickly.

In a plant pruner with a single blade cutting mechanism of the type comprising a u-shaped housing, slider, removeable single blade, and a flat cutting surface for the single blade to cut against. The plant pruner with a single blade cutting mechanism wherein said body is composed of mold injected plastic. The plant pruner with a single blade cutting mechanism of wherein said body is a u-shaped housing. The u-shaped housing wherein the top part of the u-shaped housing there is a square dado grove for the single blade to fit into. The u-shaped housing of wherein said body has a raised, flat cutting surface beneath the blade. The flat cutting surface of wherein said body is raised, the length extends the whole length of the blade and the width of the housing. The plant pruner with a single blade cutting mechanism of wherein said body houses a removeable single blade. The single blade wherein said body is a blade with an injection mold encasing the top of the blade. The injection mold of wherein the injection mold has a raised notch on one end for the slider to keep blade securely in position. The slider wherein said body is composed of injection mold. The injection mold wherein the body of the slider has a raised button on top of the slider. The slider wherein slides inside a grove in the u-shaped housing directly above the blade. The slider wherein said body has a round indentation underneath the slider which aligns with the notch on the injection mold of the single blade.

Method of using a plant pruner with single blade cutting mechanism: providing a plant pruner, providing a single blade and inserting the single blade into the plant pruner, pushing closed the slider so the single blade is securely in place, insert plant limb into plant pruner squeeze u-shaped housing closed, bringing the single blade down firmly against the flat cutting surface.

### BRIEF DESCRIPTION OF THE DRAWINGS

FIG. 1 is a side perspective illustration of the present invention.

FIG. 2 is a cross-sectional side perspective illustration of the present invention with the single blade in the closed position.

FIG. 3 is close-up cross-sectional side perspective of the present invention with the single blade in the closed position.

FIG. 4 is a cross-sectional side perspective illustration of the present invention with the single blade in the open position.

FIG. 5 is a cross-sectional side perspective illustration of the present invention in the open position.

FIG. 6 is an over-head perspective illustration of the present invention in the closed position.

FIG. 7 is an over-head perspective illustration of the present invention with the single blade in the open position.

FIG. 8 is an over-head perspective illustration of the present invention in the open position.

FIG. 9 is a side perspective illustration of the single blade of the present invention.

### DETAILED DESCRIPTION

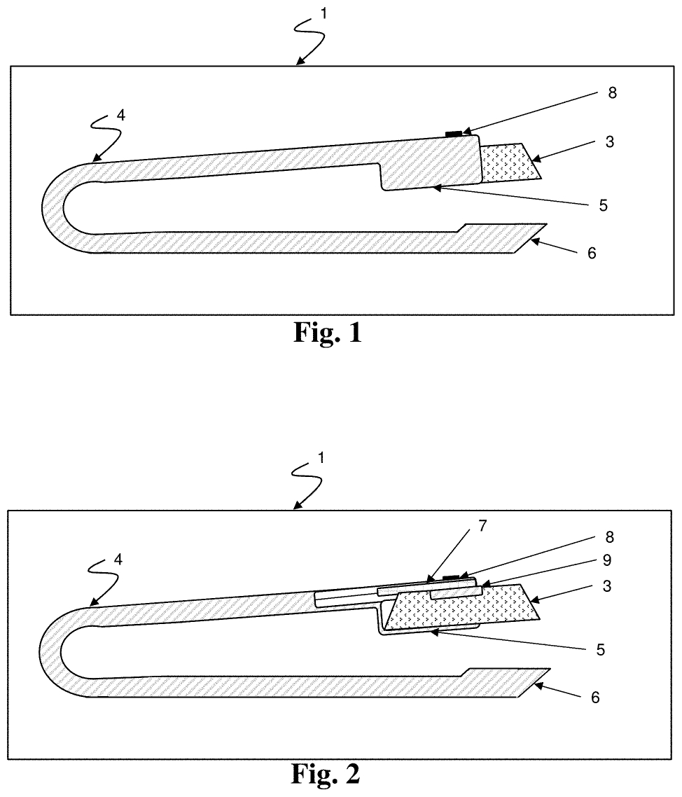

FIG. 1 illustrates the present invention of the u-shaped housing 4, blade mounting block 5, and spacer-flat surface 6 are all one piece. A single blade 3 is used because a cutting needs to have one clean, precise cut. The single blade 3 is positioned from front to back, to provide the best angle to cut. It is important to only have one blade as having more than one blade to make a cutting, damages the fibers at the end of the cutting. The embodiment of the present invention is the u-shaped housing 4 was made for easy cleaning of the tool, having bacteria get onto to surface of the tool would contaminate the cutting. The u-shaped housing 4 is also used for ease of squeezing the tool with one free hand. The blade mounting block 5 is used to angle the u-shaped housing 4 to the angle the single blade 3 closes on the spacer-flat surface 6.

FIG. 2 illustrates a cross-sectional side perspective of the present invention with the single blade in the closed position. The u-shaped housing 4, blade mounting block 5, and spacer-flat surface 6 are all one piece. The single blade 3 has a blade mount 9. The blade mount 9 of the single blade 3 sits in a square groove of the blade mounting block 5 of the u-shaped housing 4. The blade slide cover 7 slides back and forth on a slider groove. The blade slide cover 7 keeps the single blade 3 securely in place and slides back and forth for easy removal of the single blade 3. The slider nub 8 is in place to allow easy control of the blade slider cover 7.

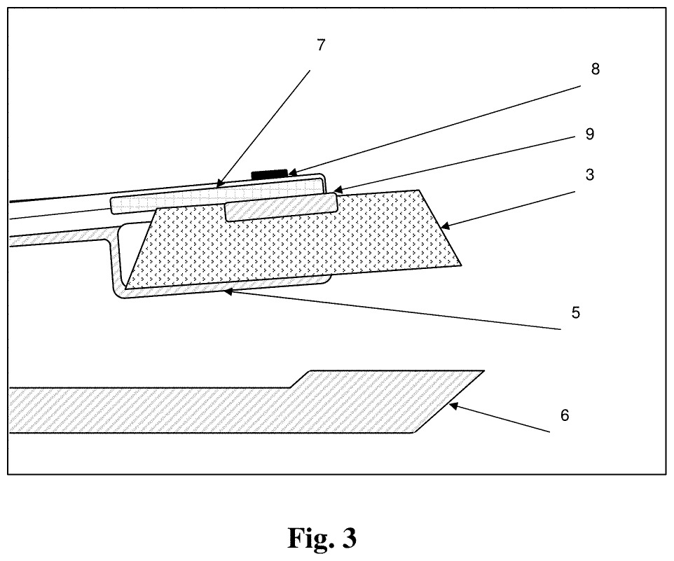

FIG. 3 illustrates a close-up cross-sectional side perspective of the present invention with the single blade in the closed position. The u-shaped housing 4, blade mounting block 5, and spacer-flat surface 6 are all one piece. The single blade 3 has a blade mount 9. The blade mount 9 of the single blade 3 sits in a square groove of the blade mounting block 5 of the u-shaped housing 4. The blade slide cover 7 slides back and forth on a slider groove. The blade slide cover 7 is in the closed position securing the single blade 3 in place. The slider nub 8 is in place to allow easy control of the blade slider cover 7.

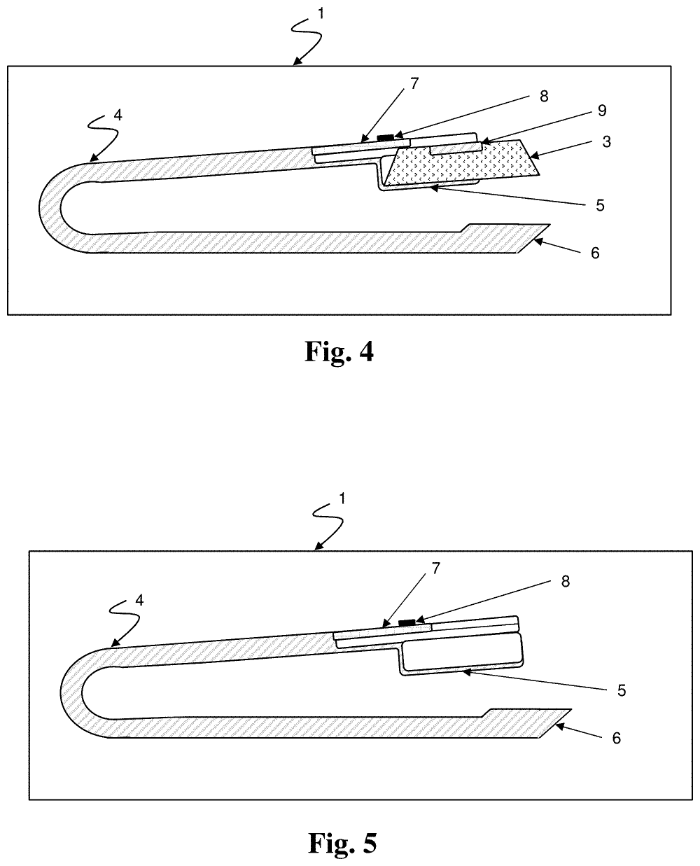

FIG. 4 illustrates a cross-sectional side perspective of the present invention with the single blade in the open position. The u-shaped housing 4, blade mounting block 5, and spacer-flat surface 6 are all one piece. The single blade 3 has a blade mount 9. The blade mount 9 of the single blade 3 sits in a square groove of the blade mounting block 5 of the u-shaped housing 4. The blade slide cover 7 slides back and forth on a slider groove. The blade slide cover 7 is in the open position allowing easy removal of the single blade 3. The slider nub 8 is in place to allow easy control of the blade slider cover 7.

FIG. 5 illustrates a cross-sectional side perspective of the present invention in the open position. The u-shaped housing 4, blade mounting block 5, and spacer-flat surface 6 are all one piece. The blade slide cover 7 slides back and forth on a slider groove. The slider nub 8 is in place to allow easy control of the blade slider cover 7.

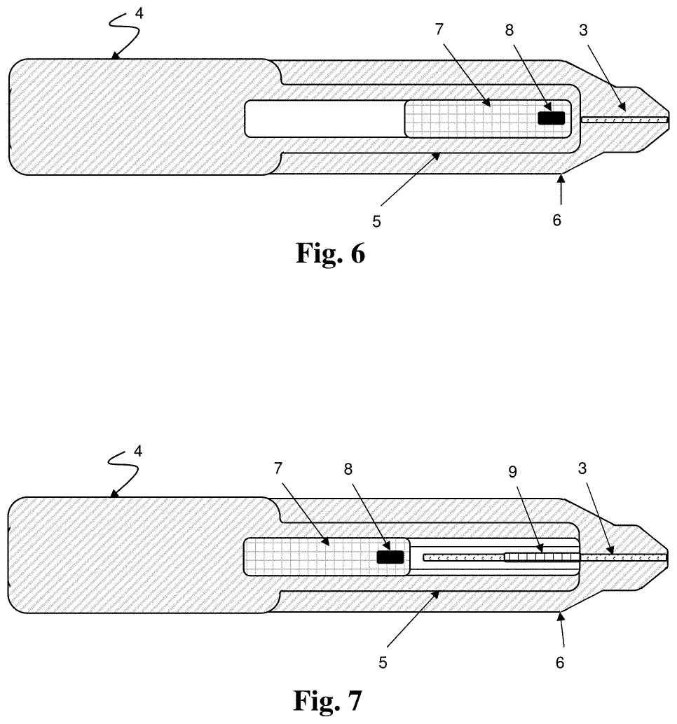

FIG. 6 is an over-head perspective illustration of the present invention in the closed position. The u-shaped housing 4 is one piece wherein the blade slider cover 7 has a raised slider nub 8 on top of the slider. The blade slider cover 7 slides inside a slider groove in the u-shaped housing 4 directly above the single blade 3. The blade slider cover 7 has a round indentation that aligns with the single blade 3.

FIG. 7 is an over-head perspective illustration of the present invention with the single blade in the open position. The u-shaped housing 4 is one piece wherein the blade slider cover 7 has a raised slider nub 8 on top of the slider. The blade slider cover 7 slides inside a slider groove in the u-shaped housing 4 directly above the single blade 3. The blade slider cover 7 has a round indentation that aligns with the blade mount 9 of the single blade 3.

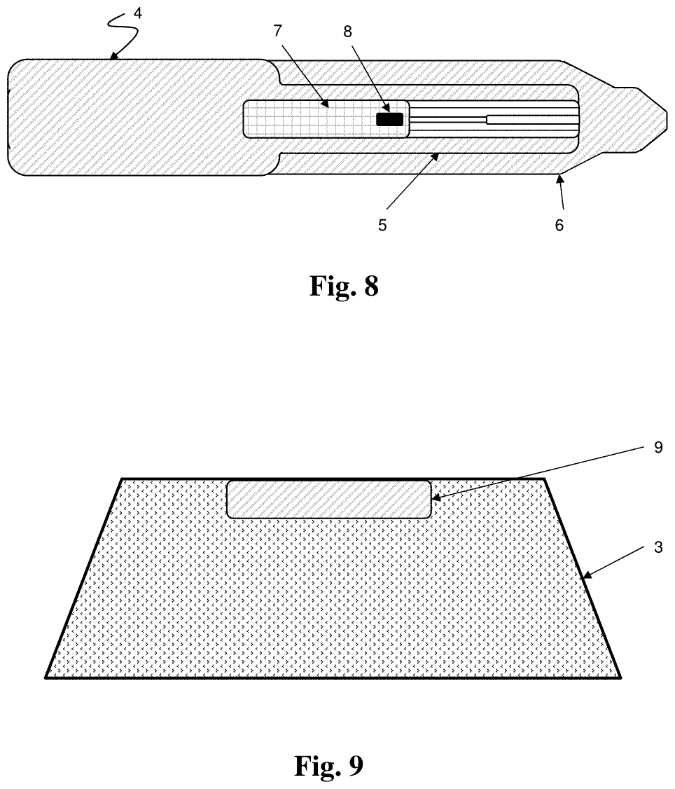

FIG. 8 is an over-head perspective illustration of the present invention in the open position. The u-shaped housing 4 is one piece wherein the blade slider cover 7 has a raised slider nub 8 on top of the slider.

FIG. 9 illustrates the blade mount 9 on the single blade 3 that enables the single blade 3 to sit in the blade mounting block 5.

The present invention can have alternative embodiments. Alternative material can be used for the housing. Alternative material that would work for housing would be fiberglass, plastic, ABS plastic, PVC Plastic, SCH 40 PVC, SCH 80 PVC Plastic, steel, stainless steel, harden steel, spring steel, aluminum or metal.

Alternative blade angles can be used. Alternative angles would be to insert the blade at a 45-degree angle or straight across. However, the blade will work at these angles the best angle is front to back.

A stop can be mounted in the center, front half of the u-shaped housing to prevent someone from over squeezing the pruner.

1. A plant pruner comprising:
a u-shaped housing with a first end portion and a second end portion each terminating in free ends, wherein the first end portion comprises:
a blade mounting block;
a recessed groove;
a single blade having a length, a height, a top width, a bottom width, and a blade mount, the single blade being sized to fit within the recessed groove and the blade mounting block, and
the single blade being sized that the single blade extends forward from the from the first end portion; and
a blade slide cover with a slider nub that secures the single blade to the first end portion; and
the second end portion comprises:
a spacer-flat surface on the second end portion in line with the forwarded extended single blade for the single blade to cut against.

2. The plant pruner of claim 1, wherein said u-shaped housing comprises one piece comprising mold injected plastic.

3. The plant pruner of claim of 1, wherein the spacer-flat surface of the second end portion of the u-shaped housing comprises a raised, flat cutting surface.

4. The plant pruner of claim 1, wherein the spacer-flat surface comprises a raised, flat cutting surface and is at least an exposed blade the length of the single blade and aligned with the single blade.

5. The plant pruner claim 1, wherein the single blade is removeable from the first end portion of the u-shaped housing.

6. The plant pruner of claim 1, wherein the blade mount of the single blade is sized to fit within the recessed dado groove and beneath the blade slide cover while still permitting the single blade to extend from the blade mounting block.

7. The plant pruner of claim 1, wherein the blade slide cover comprises mold injected plastic.

8. The plant pruner of claim 1, wherein the blade slide cover of the first end portion of the u-shaped housing aligns with the single blade to secure the single blade within the first end portion.
